(19) United States
(12) Patent Application Publication
(10) Pub. No.: US 2008/0072445 A1
(43) Pub. Date: Mar. 27, 2008

(54) Oil dipstick wiper

(76) Inventor: Frank Harrison, Kansas City, MO (US)

Correspondence Address: Wm. Bruce Day;DAY LAW FIRM, P.C., Suite 300, 4330 Belleview, Kansas City, MO, 64111-3579, US

(21) Appl. No.: 11/524,171

(22) Filed: Sep. 21, 2006

(51) Int. Cl. G01F 23/04

(52) U.S. Cl. 33/725

(57) ABSTRACT

A dipstick wiper for determining the amount of engine oil in a crank case sump is mounted to the top of the dipstick guide tube and has jaws which clip about the dipstick handle. The jaws are preferably faced with wiping material for wiping the dipstick as it is withdrawn. Additionally, the wiper jaws secure the dipstick into the inserted position in the guide tube so that it does not work loose during movement of the vehicle. A retainer clip on the jaws secures the jaws in open position after the initial wiping pass so that the stick can be reinserted and withdrawn to accurately measure the amount of oil in the sump.

### FIELD OF THE INVENTION

This invention relates to a wiper and retainer for a dipstick such as used in an engine to measure the oil retained in the crank case sump.

### BACKGROUND OF THE INVENTION

When using a dipstick to check the level of oil remaining in the crank case sump of an automotive engine, the dipstick is withdrawn from its guide tube and wiped with a rag to remove oil which has been thrown on the dipstick by the rotation of the crank shaft within the oil reservoir. After wiping, the dipstick is reinserted into the crank case and again withdrawn to provide a reading of the level of oil in the crank case, without the engine running. The person checking sometimes does not have a rag handy or is concerned about getting oil on his or her hands and regards checking the oil as a dirty job and does not like to do it. The present invention provides a means for checking the level of oil in the crank case without dirtying one's hands or requiring the use of a rag, paper towel or other such means to wipe the oil clean from the dipstick. Additionally, the present invention provides a means for more positively securing the dipstick in the lowered position to the dipstick guide tube so that the dipstick does not work loose with engine vibration.

There have been prior attempts to provide devices filling at least some of the above objects. One such device is shown in U.S. Pat. No. 4,860,401 and is in the form of a top funnel shaped piece with two passages with the first passage not having any wiping material surrounding its entrance and the second passage having wiping material at the passage entrance. The dipstick is withdrawn from one passage and inserted into the other which provides a wiping action and then again inserted into the first passage and then withdrawn to check the oil level.

The second form of dipstick wiper is disclosed in U.S. Pat. No. 4,942,669 directed to an adapter which fits over the end of the dipstick guide tube. The adapter has a lower section which squeezes upon the dipstick handle and retains it and the upper end of the top handle has funnel shaped slots into which the dipstick blade is manipulated to wipe the oil from the dipstick.

Lastly, U.S. Pat. No. 6,018,882 discloses an oil dipstick wiper of complex construction which fits over the end of the dipstick guide tube and includes a hollow housing with slotted plates and a spring which catches and wipes the oil. The structure appears needlessly complex and expensive with a result the potential purchaser is likely to pass them by in favor of something simple, easy to use and relative inexpensive.

The present is such a device and has as its objectives to provide a dipstick wiping device which is simple and easy to use and inexpensive in construction. It not only wipes the dipstick clean of residual oil on a first pass but opens so that the dipstick may be reinserted and accurately read the oil level in the crank case sump. The device securely retains the dipstick to the guide tube and does not permit it to become loose through engine vibration or movement of the vehicle.

The dipstick wiper generally comprises an elongate dipstick with a top handle and a guide tube mounted to a fluid container and enabling the dipstick to pass through the guide tube and into a fluid pool to determine the fluid level. A wiper clip is attached to the top of the guide tube and secures the dipstick by its handle in place in the guide tube. The clip opens to permit the dipstick to be unsecured and withdrawn from the tube. The wiper clip has jaws with wiping material for wiping the dipstick as it is withdrawn. The jaws are easily manipulatable so that the user may open and close the jaws. The retainer such as a clip, selectively maintains the jaws in an open position during the second wiping pass of the dipstick so that the oil level can be read.

### BRIEF DESCRIPTION OF THE DRAWINGS

FIG. 1 is a perspective view of an automobile engine showing the dipstick guide tube and the dipstick.

FIG. 2 is an enlarged elevational view of the guide tube, dipstick and dipstick wiper.

FIG. 3 is a plan view of the dipstick wiper in the jaws closed position.

FIG. 4 is a plan view of the dipstick wiper in the jaws opened position.

FIG. 5 is a perspective view of the dipstick wiper wiping the dipstick as it is withdrawn.

The invention will be more clearly understood after reference to the following detailed specification in conjunction with the drawings.

### DESCRIPTION OF THE PREFERRED AND ALTERNATE EMBODIMENTS

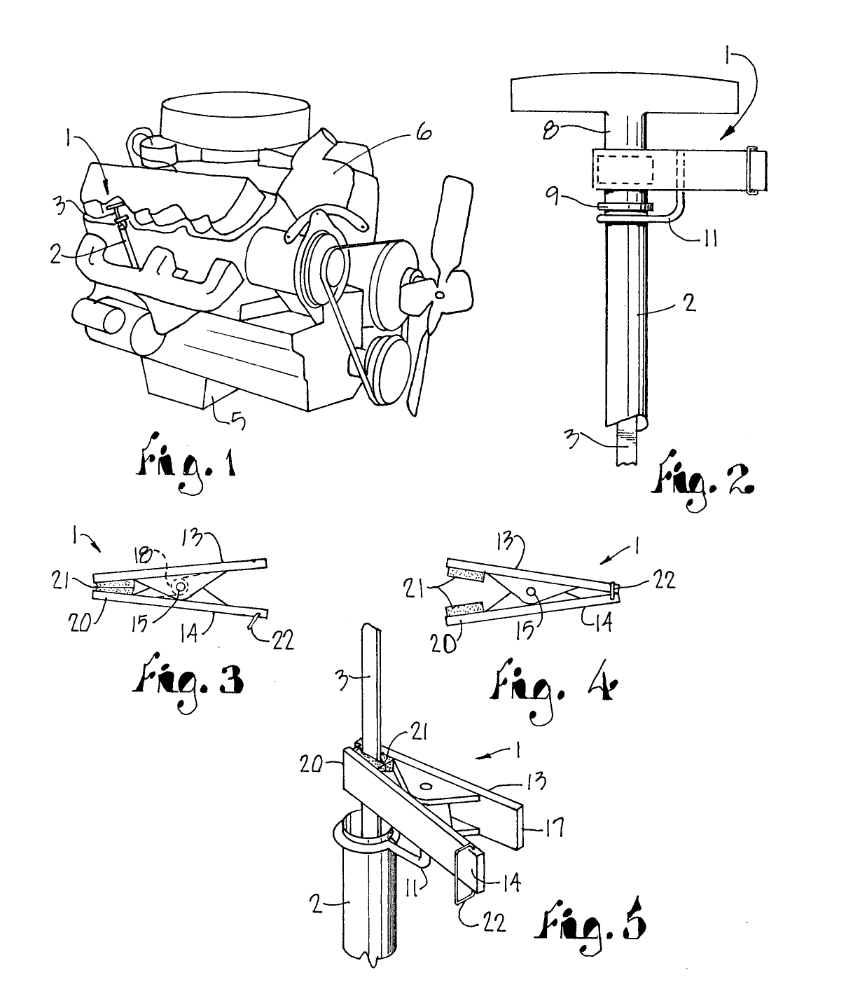

The reference no. 1, FIG. 1 generally indicates a dipstick wiper which is mounted on a dipstick guide tube 2 and into which a dipstick 3 is inserted. The dipstick 3 measures the oil quantity in crank case sump 5 of an engine 6. When the engine 6 is running, the crank shaft journals throw oil about the inside of the crank case and splatter the oil along the length of the dipstick 3 that is inserted into the crank case. To obtain an accurate reading of the oil in the sump 5, the engine must be turned off so that the fluid level stabilizes and the dipstick 3 removed by withdrawing from the guide tube 2, wiping off, then reinserting to the sump 5 and them withdrawing again so that the oil level can be read at the oil level markings on the bottom end of the dipstick 3.

Referring to FIG. 2, the dipstick 3 includes an upper T shaped handle 8 and a bottom flange 9 which abuts the upper end of the dipstick guide tube 2. The dipstick wiper 1 is mounted to the top of the dipstick guide tube 2 such as by an arm 11 which encircles the end of the guide tube 2 and extends upwardly to mount the operable parts of the wiper 1. In the illustrated example, the wiper operable parts include spaced limbs 13 and 14 that are hingedly connected ad mid points by a hinge pin 15 formed by the upper extension of the arm 11. Limbs 13 and 14 are flat, bar shaped and have outer ends 17 for manipulation, such as by squeezing together with a users finger in the manner of a clothes pin. Spring 18 formed in the manner of a clothes pin spring, FIG. 3, biases the wiper 1 to the closed position, FIG. 3. Manipulation such as by squeezing the outer end 17 together opens the inner ends 20. The inner ends 20, on the limbs of 13 and 14, are preferably fitted with wiping pads 21. These maybe bits of sponge or other absorbent or even non-absorbent wiping type material and may be removed and replaced as by adhesives. They may be a slip over type sleeve pad. At the outer ends 17 of the limbs 13 and 14 there is a retainer 22 to hold the limbs 13 and 14 in a jaws open position, FIG. 4. The retainer 22 may be a wire bale as shown or other means such as a swing arm clip held in position by outward spring pressure of the spring 18 and which falls away as spring pressure is reduced.

As will be appreciated, the purpose of the invention describe above is to enable a user to easily and quickly remove the oil or various fluids from a dipstick in order to obtain an accurate reading with out the use of paper towels, rags, etc. Although shown in connection with an automotive engine, the invention is usable with any fluid sump device including transmissions, stationary engines, fluid tanks or any such device.

The removal of the oil or fluids is achieved by spring loading opening jaws containing oil wiping pads which clean the oil or other fluid off the dipstick as it is withdrawn through the closed wiper. The pads maybe affixed to the clip permanently or manufactured as to be easily removed and replaceable. The retaining latch attached to the wipers allows for easily changing from the wiping position to the checking position. Accordingly in use, the limb ends are squeezed together slightly so as to open the inner jaws and allow it to be withdrawn by its handle from the wiper jaws, the handle flange passing through the jaws and then the wiper can be released so as to permit the fluid wiping pads to engage the surface of the dipstick and wipe fluids therefrom. After the dipstick is withdrawn from the guide tube with the fluids wiped, the retainer 22 is engaged to hold the outer ends together and the inner jaws ends apart. The dipstick is reinserted into the guide tube 2 through the open wiper jaws and the fluid level checked. After visually checking, the dipstick is again inserted into the guide tube 2 until the flange 9 bottoms out against the guide tube 2 and the retainer 22 released so as to allow the jaw ends 20 to grip about the shaft of the handle 8, thereby retaining the dipstick 3 securely in the inserted position relative to the guide tube 2. The invention is by no means pertinent to oil absorbing pads but rather the pads may be oil wiping pads or even blades such as of rubber. As used herein, both pads and blades comprise wiping material for the purpose of wiping oil from the dipstick as it is withdrawn.

The invention has been illustrated and described with respect to the preferred embodiments above identified, it will be recognized that the invention may be otherwise variously embodied and practiced within the scope of the claims which follow:

What is claimed and desired to be secured by Letters Patent is:

1. A dipstick wiper, comprising:
a) an elongate dipstick having a top handle;
b) a guide tube mounted to a fluid container and enabling the dipstick to pass through the guide tube and into a fluid pool to determine fluid level; and
c) a wiper clip attached to a top of said guide tube and securing the dipstick by its handle in place in the guide tube, the clip opening to permit the dipstick to be unsecured and withdrawn from the tube, the wiper clip having jaws with wiping material for wiping the dipstick as it is withdrawn.

2. The dipstick wiper set forth in claim 1 wherein said handle has a shaft joining the handle to the dipstick and said wiper clip fits around said handle.

3. The dipstick wiper set forth in claim 1 including a retainer for selectively maintaining said jaws in position.

4. A dipstick wiper comprising;
a) an elongate dipstick having a top handle;
b) a guide tube mounted to a fluid container and enabling the dipstick to pass through the guide tube and into a fluid pool to determine fluid level;
c) a wiper clip attached to a top of said guide tube and securing the dipstick by its handle in place in the guide tube, the clip opening to permit the dipstick to be unsecured and withdrawn form the tube, the wiper clip having jaws with wiping material for wiping the dipstick as it is withdrawn; and
d) a retainer for selectively maintaining said jaws in an open position.
